(19) United States
(12) Patent Application Publication
(10) Pub. No.: US 2021/0332835 A1
(43) Pub. Date: Oct. 28, 2021

(54) CONNECTING STRUCTURE DEVICE BETWEEN ANALYSIS ELECTRONICS AND PROBE IN CYLINDER SYSTEMS

(71) Applicant: ASTYX GmbH, Ottobrunn (DE)

(72) Inventors: Andre Giere, Oberpframmern (DE); Sebastian Lüttich, Ottobrunn (DE); Sebastian Mann, Munich (DE); Manuel Wolf, Ottobrunn (DE)

(21) Appl. No.: 17/264,585

(22) PCT Filed: Jul. 30, 2019
(86) PCT No.: PCT/EP2019/070495

§ 371 Date: Jan. 29, 2021

(30) Foreign Application Priority Data
Jul. 31, 2018 (DE) 10 2018 212 789.1

(51) Int. Cl. F15B 15/28; H01P 1/06; H01P 1/30; H01P 5/08; H01P 5/18; G01D 5/12

(52) U.S. Cl. CPC F15B 15/2869; H01P 1/061; H01P 1/30; H01R 4/02; H01P 5/183; G01D 5/12; H01P 5/085

(57) ABSTRACT

The invention relates to a device for guiding an electromagnetic wave within a cylinder head of a cylinder system, wherein the device comprises analysis electronics arranged in or on the cylinder head and a probe located in the cylinder head, as well as a connecting structure guiding the electromagnetic wave and arranged between the analysis electronics and the probe for versatile positioning of the analysis electronics, the connecting structure having a first signal connection (101, 201, 301, 401, 501a, 501b, 601, 701) for connection to the probe and a second signal connection (314, 514a, 514b, 714) for connection to the analysis electronics.

### CROSS REFERENCE TO RELATED APPLICATIONS

This application is a National Phase entry of International Patent Application No. PCT/EP2019/070495, filed on 30 Jul. 2019, which claims priority to Application No. DE 102018212789.1, filed on 31 Jul. 2018, the disclosure of which is hereby incorporated by reference in its entirety.

### TECHNICAL FIELD

The present invention relates to a device for detecting the position of a reflection body in a cylinder system.

### BACKGROUND

At present, various systems are used to detect the piston position of linear drives with pneumatic or hydraulic cylinders. The piston position can be detected discretely, i.e., at discrete points, or continuously, i.e., constantly during operation.

For the detection of discrete positions, such as end positions, magnetoresistive sensors are predominantly used, which are based on the analysis of a position-transmitting permanent magnet and therefore have a high sensitivity to external interference sources and also have a high sensitivity to electromagnetic interference sources, in particular external magnetic fields. Furthermore, such sensor systems are necessarily attached to the outside of the cylinder barrel, and the attachment is therefore not very robust to environmental influences and external interference and requires additional installation space. The device according to the application is used in the context of sensor systems that determine, for example, the distance between a reflective target and a probe in a waveguide structure.

For the continuous detection of the piston position, on the other hand, various measuring various measurement principles are used. In addition to potentiometric, magnetostrictive and inductive sensors based on the LVDT principle (Linear Variable Differential Transformer), non-contact sensors based on ultrasound or the radar principle have been used for some time. Document EP 1 040 316 describes such a device that is based on the radar principle. The technical advantage of such radar-based sensors is substantially that no changes to the plurality of related mechanical assemblies such as the piston, the end position damper, or the piston rod are required. The same applies to ultrasonic sensors, which are are only suitable for displacement measurement in pneumatic and hydraulic cylinders to a limited extent, since the properties of the dielectric, and therefore the measurement accuracy, change sharply as the cylinder pressure and the temperature of the medium change. Further causes of a change in the dielectric properties of the medium in the guiding structure can be, amongst other things, contamination, air bubbles, water in the medium or exchange of the medium. In general, the environmental properties of the medium and impurities in the medium also influence the wave propagation in the centimeter and millimeter wave range, but this disadvantage can be compensated using suitable measures. For example, the patent publication DE 10 2013 018 808 A1 describes a cylinder sensor that includes a sensor structure that takes the form of a transmission or reflection probe for reference measurement of the propagation medium in the cylinder, the sensor structure detecting the necessary parameters to correct of the distance value. Furthermore, there are additional ways of determining the environmental properties from the measurement signal and, accordingly, to compensate for those environmental properties. The radar sensor system is usually mounted at one end in the cylinder head. In this case, the analysis electronics can be integrated in the head or attached to the outside via a TEM line in the form of a connected coaxial line. The latter has proven problematic in practice, since environmental influences have a negative effect on the properties of the coaxial line, yet arbitrary positioning of external electronics is not possible. Furthermore, the use of external analysis electronics increases the complexity of the system, and when disregarded, temperature effects as well as high dispersion due to increasing cable length lead to faults in the system.

Both continuous and discrete piston position determination cannot be integrated into a cylinder, or require considerable design effort with associated high costs to do so. The reason for the considerable design effort is that all of the described existing sensor principles have to be matched to the corresponding cylinder length, since they have an excessively short detecting range. Therefore, a non-contact, microwave-based sensor principle with internal electronics is currently preferred for use. The main disadvantage of a sensor concept with internal electronics is the additional installation space required, which results in an undesired excess length of the cylinder.

### SUMMARY

The object of the present invention is to avoid the disadvantages of the prior art or to improve said disadvantages in such a way that the electronics and the probe can be better integrated and greater freedom can be achieved in respect of the positioning of the analysis electronics.

In terms of a device, this object is achieved by the features described and claimed herein.

The invention relates to a device for guiding an electromagnetic wave within a cylinder head of a cylinder system, wherein the device comprises analysis electronics that are arranged in or on the cylinder head and a probe that is located in the cylinder head as well as a connecting structure that guides the electromagnetic wave and is arranged between the analysis electronics and the probe for flexibly positioning the analysis electronics, wherein the connecting structure has a first signal connection for connection to the probe and a second signal connection for connection to the analysis electronics.

In principle, the invention enables the use of analysis electronics that are integrated in the cylinder head as well as the use of external analysis electronics. The invention achieves low-loss transmission of the electromagnetic wave to the connection path between the analysis electronics and the probe in a manner resistant to mechanical and electrical interference.

In principle, the probe serves as a low-loss waveguide adapter that converts the high-frequency signal into a mode that can be propagated in the cylindrical cavity and/or back. The probe either directly serves as a sensor component or is used to bidirectionally/unidirectionally transmit and/or receive an electromagnetic wave in order to draw conclusions about properties of the measurement environment, in particular the piston position. The probe enables excitation and reception of a dedicated mode in the waveguide, the propagation capability of which, in turn, particularly depends on the frequency of the high-frequency signal, the geometric variables, and environmental conditions, particularly the diameter of the cylindrical hollow body and the dielectric properties of the medium in the hollow body, in the case of hydraulic cylinder systems. Thus, the probe allows analysis of the cylinder properties, in particular the piston position, analysis of the medium in the cylinder, or both.

Furthermore, the flexible positioning of the analysis electronics allows the probe and the analysis electronics to be mechanically and/or spatially decoupled, which is particularly conducive to stabilizing mechanical tolerances and temperature dependencies. In addition, competitive advantages over other sensor systems are realized by the ability to replace the analysis electronics in a separate and uncomplicated manner, and the flexible positioning of the electronics reduces the installation space required in the cylinder system for this purpose.

Further advantageous refinements of the invention are the subject matter of the dependent claims.

The connecting structure may be advantageously of flexible design or preferably partially flexible design in order to simplify assembly and disassembly and, when applicable, in order to minimize temperature effects. The connecting structure may be of rigid design to allow fixed positioning of the analysis electronics. A coaxial connection may be advantageously used to transmit the electromagnetic wave, the coaxial connection being suitable for flexible deployment in the cylinder system due to its mechanical stability as well as to prevent interference radiation. In this case, the wall of the bores are provided in the cylinder head for the connection can serve as external conductors for the coaxial line. In this case, the connections of the probe and the analysis electronics preferably are not solely realized as a TEM line. Arbitrary angles can be realized between the first signal connection and the second signal connection. As a result, all degrees of freedom in the mechanical design of the cylinder system can be realized. The angle between the first signal connection and the second single connection is preferably 90 degrees.

The conductor structure can also be implemented as a hybrid of various conductor structures in order to minimize the connecting points between the assemblies and therefore to utilize the installation space in an optimum manner. For example, the combination of a coaxial line and a strip line type on a printed circuit board has proven particularly advantageous for mechanically decoupling the probe from the analysis electronics. Particularly when implemented on a printed circuit board, there are no general reasons why other types of lines that do not necessarily have a TEM field type cannot be used to implement the connection. Strip lines and preferably microstrip lines (MSL) can be advantageously used, wherein these are particularly suitable for internal operation in cylinder systems and are preferably used for short distances. Alternative strip line technologies, such as an MSL-like Grounded Coplanar Waveguide (gCPW) for example, can also be used in principle.

A galvanic contact can be advantageously made between the first signal connection and the second signal connection, wherein the galvanic contact of the connection can take place in various ways, depending on the prevailing boundary conditions. The following methods of making contact are possible for establishing galvanic contact between the signal connections of the probe and the analysis electronics:
elements with spring effect in the form of spring contacts,
plug-in or clamping connections,
screw or press connections and
solder connections,
   wherein spring contacts have the highest degree of flexibility and, in contrast, screw connections, press connections and solder connections are considered to be mechanically rigid.

The galvanic contact can preferably be achieved in the form of an element with spring effect. The contact between the probe and the analysis electronics with spring contacts can be implemented in coaxial systems, for example, with so-called spring contact pins consisting of a sleeve with a spring and a contact pin, wherein spring contacts are particularly advantageous when high forces and mechanical stresses occur. Said contacts can be implemented on a printed circuit board by bent sheet-metal parts that exhibit spring effect or with contact pins which are suitable for assembly. In addition to installation tolerances during manufacture, such contacts also allow axial and radial movement of the signal line coming from the probe, particularly coming from the probe's internal conductors, during operation. This can prove advantageous particularly when high forces prevail in the high-pressure systems, since the internal conductors in such systems are known to move relative to the cylinder head depending on the pressure. Therefore, mechanical closing of the contact point can be counteracted by a moving contact. Conductive elastomers or foams which are coated with a conductive film constitute an alternative approach to implementing contacts with spring effect. When assembled under preload, these follow the movement of the moving contact, wherein high mechanical strength and elasticity of the connecting structure are achieved.

Plug-in or clamping connections can allow for tolerances during installation, but are considered less flexible during operation and particularly experience wear due to abrasion of the contact areas during operation. However, installation tolerances and offsets that arise between individual components can be compensated. Furthermore, these types of connections exhibit good temperature resistance. Mechanically rigid connections between the electronic circuit and the probe, which enable simple assembly and disassembly, can be achieved by using screw and press connections in the form of interference fits and press fits. A press fit using conductive elastomers is preferably used or a solder connection is preferably used. Such connections can experience heavy wear or can be irreversibly damaged when high forces and mechanical stresses occur, for example on account of temperature gradients of the materials involved. Therefore, spring contacts are particularly preferred when high forces and steep temperature gradients occur.

Greater insensitivity to tolerances that arise in the axial and radial direction of the cylinder, and also to manufacturing tolerances that arise during production can be achieved by using flexible connections in the form of spring contacts. In this case, both the contact points and assembly points in the cylinder head are taken into consideration, but consideration is also given to the influence on the connecting piece itself at the same time. For example, conductor technologies that are selected in a targeted manner exhibit greater insensitivity to bore hole tolerances. Due to the connection of the analysis electronics and the probe, an integration concept that compensates for tolerances, e.g., axial, radial and manufacturing tolerances of the contact points and assembly points, can be realized. Furthermore, the integration concept enables less exacting tolerances to be used to manufacture the mechanical components. A further advantage of the integration concept can arise when the design is such that, for example, the order in which the probe and the analysis electronics are assembled can be freely configured. This also has a positive effect on the ability to replace individual components. For example, a competitive advantage over other sensor systems can arise from the ability to replace the analysis electronics in a separate and uncomplicated manner. If the integration concept enables impedance transformation between the analysis electronics and the probe, this, in turn, can have a positive effect on the size of the sensor system. While the electronics are frequently based on a 50-ohm line characteristic impedance, the base impedance of the probe can be chosen nearly without any restriction. Therefore, the necessary installation space for the sensor can be significantly reduced due to the impedance transform stages being shifted from the probe to the feed line.

In addition to galvanic connections, galvanically isolated signal connections are also used to connect the analysis electronics and the probe to reduce interference signals and to enable signal transmission without delays. Such a connection is made when, for example, the coupler for isolating transmission and reception signals is integrated into the connection. In this case, the coupler can be realized by a conducting structure or integrated in the form of a galvanically isolated discrete component on a printed circuit board. The galvanic isolation is expediently implemented between the first signal connection and the analysis electronics, wherein galvanic isolation of the signal connections is achieved by using conductors which are guided in parallel.

The device can avoid temperature effects and relatively high dispersion as the conductor length increases by providing additional functionalities in the connecting piece between the analysis electronics and the probe. Calibration structures which can be connected or are integrated in the signal connection are to be mentioned, said calibration structures, in combination with suitable methods, allowing the properties of the electronic circuit and of the connecting piece to be eliminated up to the calibration plane. Using one or more analog or digital temperature sensors further enables the monitoring of the temperature response of the connection between the probe and the analysis electronics in order to then compensate for the temperature response during signal analysis using a suitable method.

An electromagnetic wave in the high-frequency range of between 10 MHz and 100 GHz can be fed in. Depending on the dimensions of the cylinder and wave mode used as the line structure, a suitable frequency is selected which is higher than the lower limit frequency of the wave mode used. In this context, using a plurality of frequencies enables a higher degree of accuracy since uncorrelated measurement errors can be averaged out.

Further advantages, features and possible applications of the present invention can be found in the following description of preferred exemplary embodiments in conjunction with the drawings.

### BRIEF DESCRIPTION OF DRAWINGS

FIG. 1A shows a schematic sectional illustration of a cylinder system comprising external analysis electronics in generalized form.

FIG. 1B shows a schematic sectional illustration of a cylinder system comprising internal analysis electronics in generalized form.

FIG. 2 shows a perspective illustration of an embodiment of the connecting structure according to the application with a 90-degree connection between a coaxial line which leads to the probe and a microstrip line which leads to the analysis electronics using a spring contact metal sheet on a printed circuit board.

FIG. 3 shows a sectional illustration of an embodiment of the connecting structure according to the application with a connection between two coaxial lines using a spring contact pin.

FIG. 4 shows a sectional illustration of an embodiment of the connecting structure according to the application with a straight connection between two coaxial lines using a spring contact pin.

FIG. 5 shows a perspective illustration of an embodiment of the connecting structure according to the application with a screwed press connection between a coaxial line coming from the probe and a microstrip line, which leads to the analysis electronics, with a printed circuit board.

FIG. 6A shows a perspective illustration of an embodiment of the connecting structure according to the application with an L-shaped connection between two coaxial lines using a clamping connection with a spring-action rotary part.

FIG. 6B shows a sectional illustration of the embodiment according to FIG. 6A.

FIG. 7 shows a sectional illustration of an embodiment of the connecting structure according to the application with an L-shaped connection between two coaxial lines using a clamping connection.

FIG. 8 shows a sectional illustration of an embodiment of the connecting structure according to the application with a straight connection between two coaxial lines using a pressed plug-in contact at the internal conductor and a press connection at the external conductor.

### DETAILED DESCRIPTION

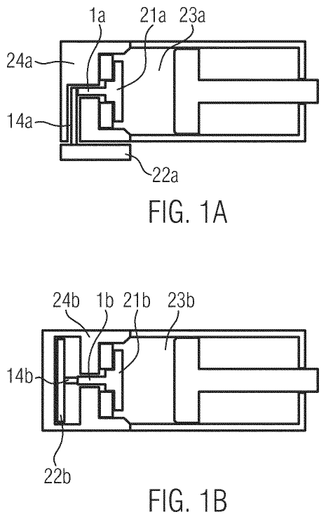

FIG. 1A schematically shows the sectional illustration of a cylinder system comprising the device according to the application in which the analysis electronics (22a) of a sensor system are arranged externally. In the case of external implementation, a connection between the probe (21a) and the analysis electronics (22a) is provided by a bore or milled portion in the cylinder wall of the cylinder head (24a). A coaxial connection is preferably used to transmit the electromagnetic wave.

FIG. 1B schematically shows the sectional illustration of a cylinder system comprising the device according to the application in which the analysis electronics (22b) of the sensor system are arranged internally. In the case of the internal implementation, the analysis electronics (22b) are preferably arranged in the cylinder head (24b) of the cylinder system in a cavity close to the probe (21b). A short coaxial line is preferably used to connect the analysis electronics (22b).

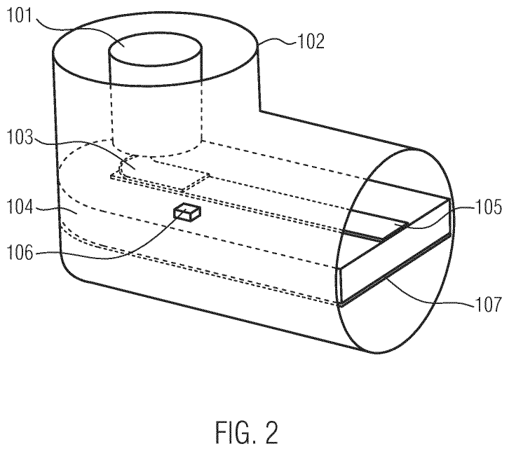

FIG. 2 shows a perspective view of an embodiment of the connecting structure according to the application in which a 90-degree connection is realized between a coaxial signal connection (101) that leads to the probe and a signal connection that leads to the analysis electronics. The signal connection that leads to the analysis electronics is a microstrip line, preferably a Grounded Coplanar Waveguide (gCPW)-type microstrip line that is guided into a bore hole. The galvanic contact is achieved with the aid of one or more spring contact metal sheets (103) that can be manufactured, for example, from copper-beryllium or other conductive materials with corresponding spring properties. The copper contact sheet (103) is arranged on the signal path of the microstrip line (105). When designing the signal path, attention should be given to the power distribution at the contact point and the inductive influence of the spring contact metal sheet (103). The use of a dedicated network for impedance matching, preferably on the printed circuit board (104) and/or in the coaxial system, can prove expedient, but is not absolutely necessary given correct design of the spring contact metal sheet (103). Furthermore, one or more analog and/or digital temperature sensors (106) are arranged on the printed circuit board (104), which temperature sensors monitor the temperature response of the connection between the probe and the analysis electronics in order to compensate for this temperature response by means of a suitable method during the signal analysis.

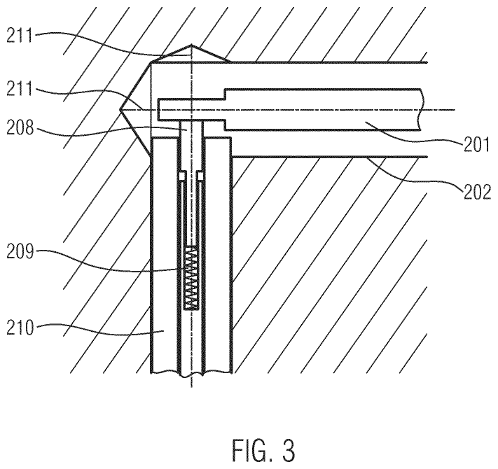

FIG. 3 shows the sectional illustration of an embodiment of the connecting structure according to the application in which an L-shaped connection is realized between the two signal connections. The first signal connection and the second signal connection are each a coaxial connection, wherein a spring contact pin (208) is used as a mechanically flexible connecting element in order to generate a coaxial angled system.

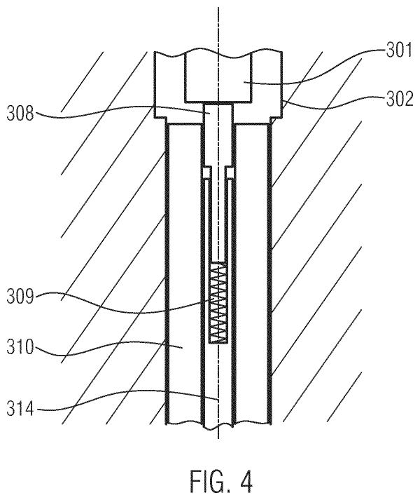

FIG. 4 likewise shows the sectional illustration of an embodiment of the connecting structure according to the application in which a straight connection is implemented between the two signal connections (301, 314). As in FIG. 3, the first signal connection (301) and the second signal connection (314) in FIG. 4 are each a coaxial connection, wherein a spring contact pin (308) is used as the mechanically flexible connecting element.

FIG. 3 and FIG. 4 show spring contacts as the mechanically flexible connecting element in straight and angled coaxial systems. In both illustrations, the external conductor (202, 302) of the coaxial line is formed by the wall of the bore holes (211) in the cylinder head. The internal conductors of the lines to the probe (201, 301) or to the electronics (314) are achieved in the illustration using spring contact pins (208, 308) which are spring-mounted in a sleeve (210, 310). In this case, the spring (209, 309) generates pressure on the contact point in the axial direction. A dielectric sleeve (210, 310) provides for mechanical stability of the contact system in the radial direction and additionally serves for impedance matching of the change in bore diameter that arrises.

In addition to partially or entirely flexible connections, rigid connections in the form of a screw or press connection, an interference fit, as well as a solder connection can be used as an interface between the analysis electronics and the probe.

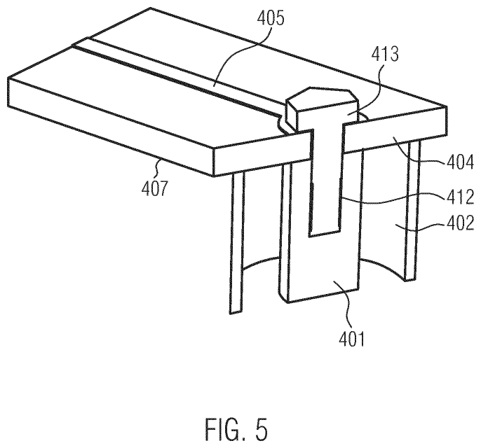

FIG. 5 shows a perspective illustration of an embodiment of the connecting structure according to the application that includes a screwed press connection between a coaxial line (401) coming from the probe and a microstrip line (405), which leads to the analysis electronics, with a printed circuit board. Said figure shows a rigid press connection, wherein the electrical contact of external conductors and internal conductors of the coaxial line is made by a press connection on the printed circuit board, and wherein contact pressure is applied by a screw (413) that is tightened with a defined torque.

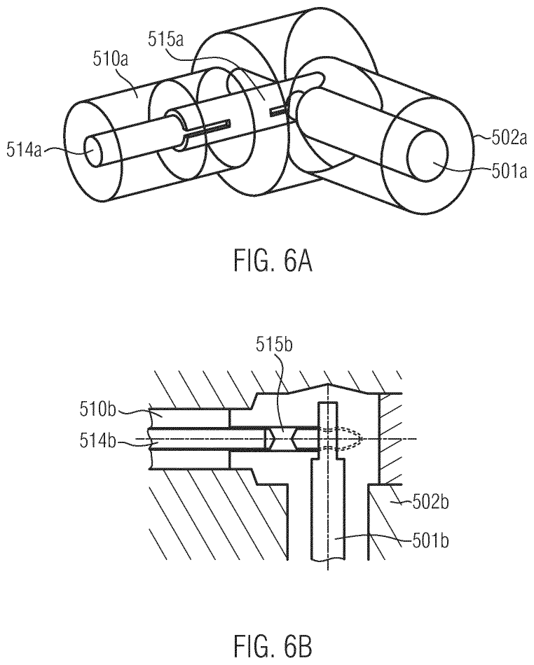

FIGS. 6A and 6B show a perspective illustration and, respectively, a sectional illustration of a likewise flexible, galvanic connection with a plug-in or clamping connection in coaxial form. The connection of the internal conductor of the coaxial line (501a, 501b) that leads to the probe and the connection of the electronics (514a, 514b) is realized by a spring-action rotary part (515a, 515b) or bent sheet-metal part, for example composed of brass or copper-beryllium, which is applied to one of the two internal conductors, for example, by adhesive bonding or soldering. The spring-action rotary part (515a, 515b) is formed in a partially slotted manner in the axial direction, so that the groove has a spring effect, firstly, in order to enable insertion of the mating piece and, secondly, to ensure reliable securing in the latched state. The spring-action rotary part (515a, 515b) has to be designed both in mechanical and electrical respects in order to meet the requirements of the transmission path. In particular, the choice of the material and also a shape which permits direct current flow in the axial direction have proven essential for the high-frequency properties of the connection. Furthermore, low parasitic capacitances between the rotary part (515a, 515b) and the cylinder wall (502a, 502b), which serves as external conductor, should be ensured when configuring the spring-action rotary part (515a, 515b) with a solder and clamping connection.

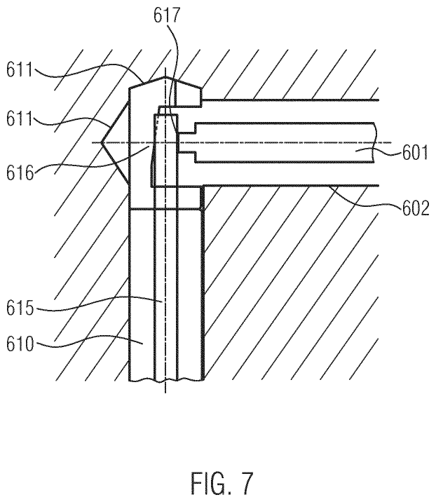

FIG. 7 shows a sectional illustration of an embodiment of the connecting structure according to the application that includes a press connection in a coaxial system. The coaxial conductors coming from the probe and the analysis electronics form a right angle to one another and the walls of the bore holes (611) in the cylinder head form the external conductors (602) of the connection. The press contact is implemented by a dielectric clamping wedge (616) with a preferred direction, the clamping wedge defining the flexible internal conductor coming from the electronics and pressing onto the rigid internal conductor to establish the connection to the probe.

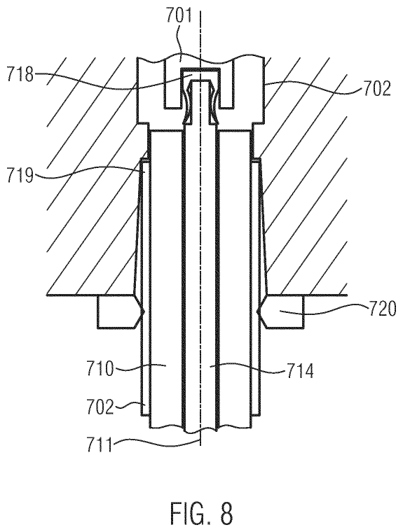

FIG. 8 shows a sectional illustration of an embodiment of the connecting structure according to the application that includes a straight connection of two coaxial lines, wherein the connection of the internal conductors is made by means of a pressed-in contact element (718) and the external conductors are electrically connected via a press connection (719).

Furthermore, a cylinder system comprising external electronics is described in general in FIG. 1A (at the top). FIG. 1B (at the bottom) describes a cylinder system comprising internal electronics. FIG. 2 describes a connection of the analysis electronics and the probe using a printed circuit board with a metal spring sheet. FIG. 3 describes an L-shaped connection of the analysis electronics and the probe using coaxial conductors with a spring contact pin. FIG. 4 describes a straight connection of the analysis electronics and the probe using a spring contact pin and coaxial conductors. FIG. 5 describes a connection of the analysis electronics and the probe using a screwed press connection with a printed circuit board and a coaxial line. FIG. 6A (at the top) describes an L-shaped connection of the analysis electronics and the probe with a coaxial design using a clamping connection with a spring-action rotary part in a perspective illustration. FIG. 6B (at the bottom) describes an L-shaped connection of the analysis electronics and the probe with a coaxial design using a clamping connection with a spring-action rotary part in a sectional illustration. FIG. 7 describes an L-shaped connection of the analysis electronics and the probe using a clamping connection. FIG. 8 describes a straight connection of the analysis electronics and the probe using a pressed-in plug-in contact at the internal conductor and a press connection of the external conductors.

1. A device for guiding an electromagnetic wave within a cylinder head of a cylinder system, comprising:
analysis electronics arranged in or on the cylinder head;
a probe located in the cylinder head; and
a connecting structure configured to guide the electromagnetic wave, wherein the connecting structure is arranged between the analysis electronics and the probe, and the connecting structure comprises a first signal connection connected to the probe and a second signal connection connected to the analysis electronics.

2. The device of claim 1, wherein the connecting structure is flexible.

3. The device of claim 1, wherein the connecting structure is rigid.

4. The device of claim 1, wherein the connecting structure is a coaxial connection configured to transmit the electromagnetic wave.

5. The device of claim 1, wherein the first signal connection and the second signal connection are reconfigurable to different angles with respect to each other.

6. The device of claim 1, wherein the first signal connection and/or the second signal connection are/is configured on a printed circuit board (104, 404).

7. The device of claim 1, wherein the first signal connection and/or the second signal connection are/is configured as a coaxial connection on a printed circuit board.

8. The device of claim 1, wherein the connecting structure further comprises strip lines.

9. The device of claim 1, comprising a galvanic contact between the first signal connection and the second signal connection.

10. The device of claim 9, wherein the galvanic contact is configured as an element with spring effect.

11. The device of claim 10, wherein the galvanic contact is configured as a spring contact, a conductive elastomer, or a conductive film-over-foam contact.

12. The device of claim 9, wherein the galvanic contact is configured as a plug-in connection or a clamping connection.

13. The device of claim 9, wherein the galvanic contact is configured as a screw connection or a press connection.

14. The device of claim 13, wherein the screw connection or the press connection is: configured as
an interference fit; or
a press fit.

15. The device of claim 9, wherein the galvanic contact is configured as a solder connection.

16. The device of claim 1, wherein the first signal connection and/or the second signal connection are/is galvanically isolated, and wherein the device further comprises coupling structures configured as one or more signal lines guided in parallel.

17. The device of claim 16, wherein the galvanic isolation is configured between the first signal connection and the analysis electronics.

18. The device of claim 16, further comprising directional couplers integrated into the one or more signal lines.

19. The device of claim 16, further comprising calibration structures integrated into the one or more signal lines.

20. The device of claim 1, further comprising analog or digital temperature sensors configured to monitor a temperature, wherein the temperature sensors are provided at the connecting structure.

21. The device of claim 1, wherein the electromagnetic wave has a frequency in a range from 10 MHz to 100 GHz.
